(19) United States
(12) Patent Application Publication
(10) Pub. No.: US 2010/0123681 A1
(43) Pub. Date: May 20, 2010

(54) TOUCH PANEL AND TOUCH DISPLAY PANEL

(75) Inventors: Yuan-Chun Wu, Taoyuan County (TW); Hsin-Hung Lee, Hsinchu City (TW); Mei-Sheng Ma, Taipei City (TW); Kuo-Hsing Cheng, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/468,072

(22) Filed: May 19, 2009

(30) Foreign Application Priority Data
Nov. 19, 2008 (TW) 97144760

(51) Int. Cl. G06F 3/045

(52) U.S. Cl. 345/174; 349/106

(57) ABSTRACT

A touch panel and a touch display panel are provided. The touch panel includes a substrate on which a touch layer and a color filter layer are disposed. The touch layer includes touch electrodes, signal lines, and a shielding layer. Each signal line is electrically connected only to one touch electrode. The touch display panel includes an array substrate, a color filter substrate having a touch area and a non-touch area, and a liquid crystal layer. The color filter substrate includes touch electrodes, signal lines, color filter patterns, and a shielding layer which has transparent areas. The touch electrodes are disposed in the touch area and above the shielding layer. The signal lines are disposed above the shielding layer. Each signal line is connected only to one touch electrode. The color filter patterns are disposed above the touch electrode and correspond to the transparent areas of the shielding layer.

### CROSS-REFERENCE TO RELATED APPLICATION

This application claims the priority benefit of Taiwan application serial no. 97144760, filed on Nov. 19, 2008. The entirety of the above-mentioned patent application is hereby incorporated by reference herein and made a part of specification.

### BACKGROUND OF THE INVENTION

1. Field of the Invention

The present invention relates generally to a panel structure, and more particularly, to a touch panel and a touch display panel.

2. Description of Related Art

In current information era, human beings by degrees tend to rely on electronic products. The electronic products such as mobile phones, handheld personal computers (PCs), personal digital assistants (PDAs) and smart phones have pervaded everywhere in our daily life. To meet current demands on portable, compact, and user-friendly information technology (IT) products, touch panels have been introduced as input devices in replacement of conventional keyboards or mice. Among the touch panels, a touch display panel capable of performing both a touch function and a display function is one of the most popular products at present.

FIG. 1 is a schematic partial cross-sectional view of a conventional added-type touch display panel. Referring to FIG. 1A, the touch display panel 100 includes a display panel 110, a touch panel 120, and an optical adhesive 130 for adhering the display panel 110 to the touch panel 120. Here, the display panel 110 is a liquid crystal display (LCD) which is able to achieve a multi-color display effect. The LCD includes an array substrate 112, a liquid crystal layer 114, and a color filter substrate 116. The touch panel 120 is a capacitance touch panel and includes a substrate 122, a plurality of lower electrodes 124, a dielectric layer 126, and an upper electrode 128. When a user presses the touch panel 120, the capacitance value between the upper electrode 128 and the lower electrodes 124 is changed, and thereby frames or images displayed on the display panel 110 can be further changed based on the user's choices.

Nonetheless, the thickness of the added-type touch display panel is not likely to be reduced, and therefore an integrated-type touch display panel has been proposed. FIG. 1B is a schematic partial cross-sectional view of a conventional integrated-type touch display panel. Referring to FIG. 1B, the integrated-type touch display panel 100a includes an array substrate 112, a liquid crystal layer 114, an electrode layer 140, a color filter layer 142, a touch layer 144, and a substrate 148. The touch layer 144 includes a plurality of touch electrodes 146 and a plurality of signal lines (not shown) which are connected to the touch electrodes 146. In general, the touch electrodes are distributed into a display area of the entire touch display panel, and one signal line is connected to a plurality of touch electrodes. As such, the excessive touch electrodes result in excessive parasitic capacitance, thereby negatively affecting sensitivity of the touch display panel. Moreover, the layout of the touch electrodes complicates the manufacturing process of the touch display panel, therefore reducing yield thereof.

### SUMMARY OF THE INVENTION

The present invention is directed to a touch display panel equipped with touch electrodes and signal lines.

The present invention is further directed to a touch panel capable of performing both a touch function and a color filtering function.

In the present invention, a touch display panel including an array substrate, a color filter substrate, and a liquid crystal layer is provided. The color filter substrate is disposed opposite to the array substrate and has a touch area and a non-touch area. Besides, the color filter substrate includes a shielding layer, a plurality of touch electrodes, a plurality of signal lines, and a plurality of color filter patterns. The shielding layer has a plurality of transparent areas. The touch electrodes are disposed in the touch area and above the shielding layer. The signal lines are disposed above the shielding layer, and each of the signal lines is connected to only one of the touch electrodes. The color filter patterns are disposed above the touch electrodes and correspond to the transparent areas of the shielding layer. The liquid crystal layer is sandwiched between the array substrate and the color filter substrate.

In an embodiment of the present invention, the touch electrodes include a plurality of first touch electrodes and a plurality of second touch electrodes. The signal lines include a plurality of first signal lines and a plurality of second signal lines. Each of the first signal lines is connected to only one of the first touch electrodes and extends along a first direction, and each of the second signal lines is connected to only one of the second touch electrodes and extends along a second direction.

In an embodiment of the present invention, the first direction is different from the second direction.

In an embodiment of the present invention, a material of the touch electrodes is a transparent conductive material.

In the present invention, a touch display panel including an array substrate, a color filter substrate, and a liquid crystal layer sandwiched between the array substrate and the color filter substrate is provided. The color filter substrate is disposed opposite to the array substrate and has a touch area and a non-touch area. Besides, the color filter substrate includes a plurality of touch electrodes, a plurality of signal lines, a shielding layer, and a plurality of color filter patterns. The touch electrodes are disposed in the touch area, and each of the touch electrodes has a plurality of transparent areas. Each of the signal lines is electrically connected only to only one of the touch electrodes. The shielding layer is disposed corresponding to gaps among the touch electrodes. The color filter patterns are disposed above the touch electrodes and the shielding layer and correspond to the transparent areas of the touch electrodes.

In an embodiment of the present invention, the touch electrodes include a plurality of first touch electrodes and a plurality of second touch electrodes. The signal lines include a plurality of first signal lines and a plurality of second signal lines. Each of the first signal lines is connected to only one of the first touch electrodes and extends along a first direction, and each of the second signal lines is connected to only one of the second touch electrodes and extends along a second direction.

In an embodiment of the present invention, a material of the transparent areas is a transparent conductive material.

In the present invention, a touch panel including a substrate, a touch layer, and a color filter layer is provided. The touch layer is disposed on the substrate and includes a first touch electrode, a first signal line, and a shielding layer. The first signal line is electrically connected only to the first touch electrode. The color filter layer is disposed on the substrate.

In an embodiment of the present invention, the first touch electrode has a non-transparent area and a transparent area.

In an embodiment of the present invention, the touch layer further includes a first insulating layer disposed on the substrate.

In an embodiment of the present invention, the first insulating layer is disposed between the first touch electrode and the shielding layer.

In an embodiment of the present invention, the first insulating layer is disposed between the first touch electrode and the color filter layer.

In an embodiment of the present invention, the first insulating layer is disposed between the shielding layer and the color filter layer.

In an embodiment of the present invention, the touch layer further includes a second touch electrode and a second signal line, and the second signal line is electrically connected only to the second touch electrode.

In an embodiment of the present invention, the second touch electrode has a non-transparent area and a transparent area.

In an embodiment of the present invention, the touch layer further includes a second insulating layer disposed on the substrate.

In an embodiment of the present invention, the second insulating layer is disposed between the second touch electrode and the first touch electrode.

In an embodiment of the present invention, the second insulating layer is disposed between the second touch electrode and the shielding layer.

In an embodiment of the present invention, the second insulating layer is disposed between the second touch electrode and the color filter layer.

In an embodiment of the present invention, the first signal line is parallel to the second signal line.

In an embodiment of the present invention, a primary gap exists between the first touch electrode and the second touch electrode.

In an embodiment of the present invention, the shielding layer includes a primary shielding area corresponding to the primary gap.

In an embodiment of the present invention, the color filter layer includes a plurality of color filter patterns, and a secondary gap exists between every two of the color filter patterns.

In an embodiment of the present invention, the shielding layer further includes a secondary shielding area corresponding to the secondary gap.

In the present invention, a touch display panel including an array substrate, the touch panel disclosed above, and a liquid crystal layer is provided. The touch panel is disposed opposite to the array substrate. The liquid crystal layer is sandwiched between the array substrate and the touch panel.

According to the present invention, the touch panel is equipped with both the touch function and the color filtering function. Therefore, the touch panel and the array substrate are assembled, and the liquid crystal layer fills therebetween, such that the touch display panel is formed. In comparison with the conventional touch display panel formed by adhering the touch panel to the display panel, a thickness of the touch display panel of the present invention is rather thin.

Moreover, in the touch display panel of the present invention, each of the signal lines is electrically connected only to only one of the touch electrodes, such that the number of the touch electrodes in the panel is decreased. As such, the unfavorable sensitivity of the touch display panel resulting from the excessive parasitic capacitance which is generated by the excessive touch electrodes can be prevented.

To make the above and other features and advantages of the present invention more comprehensible, several embodiments accompanied with figures are detailed as follows.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A is a schematic partial cross-sectional view of a conventional added-type touch display panel.

FIG. 1B is a schematic partial cross-sectional view of a conventional integrated-type touch display panel.

FIG. 2A is a schematic top view of a touch display panel according to an embodiment of the present invention.

FIG. 2B is a schematic cross-sectional view taken along a line I-I′ in FIG. 2A.

FIG. 2C is a schematic partial cross-sectional view of FIG. 2B.

FIG. 3A is a schematic top view of a touch display panel according to another embodiment of the present invention.

FIG. 3B is a schematic top view of a touch display panel according to still another embodiment of the present invention.

FIGS. 4 to 8 are schematic partial cross-sectional views of a touch panel according to other embodiments of the present invention.

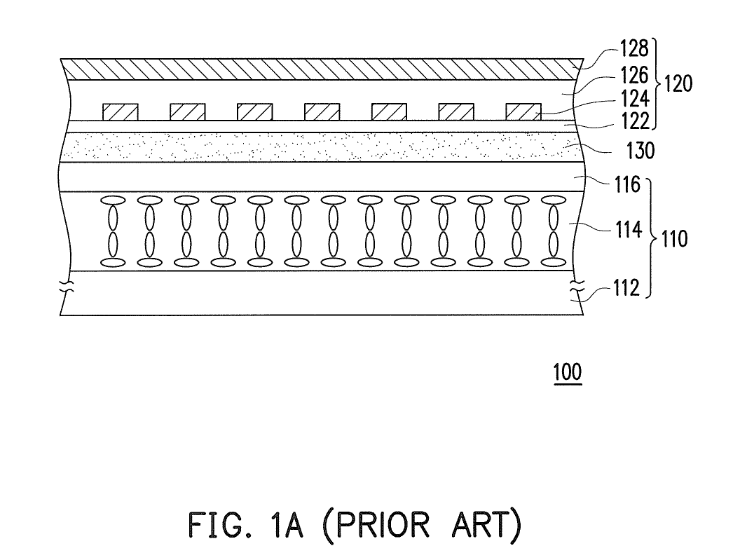

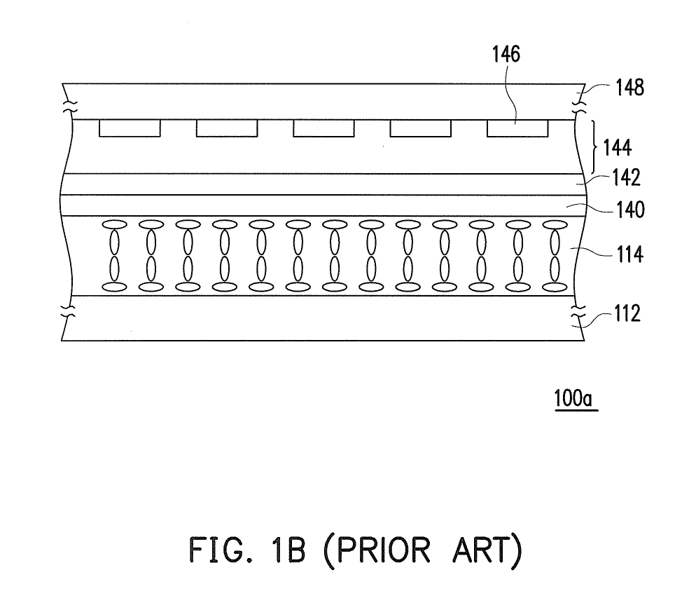

### DESCRIPTION OF EMBODIMENTS

### Touch Display Panel

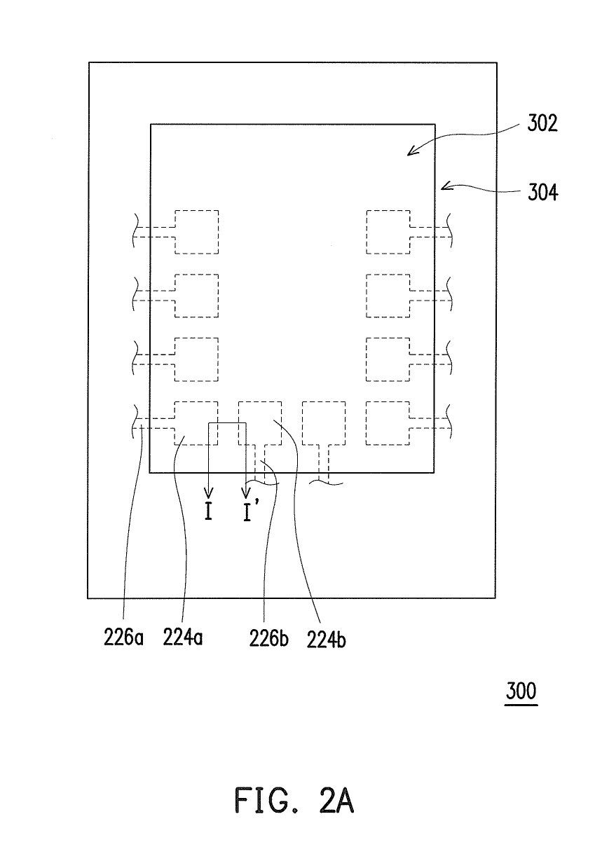

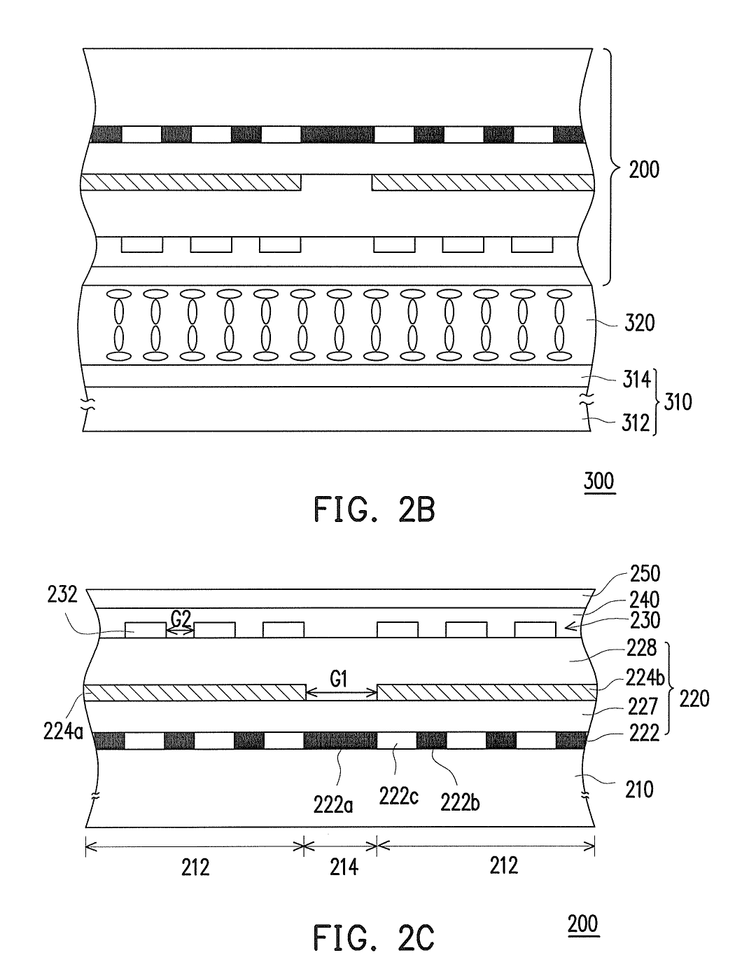

FIG. 2A is a schematic top view of a touch display panel according to an embodiment of the present invention. FIG. 2B is a schematic cross-sectional view taken along a line I-I′ in FIG. 2A.

Referring to FIG. 2A, the touch display panel 300 includes a display area 302 and a non-display area 304. In the present embodiment, electrodes 224a and 224b serving as touch electrodes are disposed in the display area 302. Signals lines 226a and 226b are connected to the touch electrodes 224a and 224b, extend from the touch electrodes 224a, 224b to the non-display area 304, and are electrically connected to corresponding devices or circuits (not shown). In the present embodiment, the touch electrodes 224a are arranged at two opposite sides of the display area 302, and the touch electrodes 224b are arranged at the bottom side of the display area 302. The bottom side having the touch electrodes 224b is arranged and connected between the two opposite sides having the touch electrodes 224a. However, the number of the touch electrodes 224a, 224b and the positions thereof in the display area 302 are not limited in the present invention. Each of the signal lines 226a is connected to only one of the touch electrodes 224a and extends along a first direction (e.g. horizontal direction). Each of the signal lines 226b is connected to only one of the touch electrodes 224b and extends along a second direction (e.g. vertical direction). In the present embodiment, the first direction is different from the second direction.

Based on the above, referring to the cross-sectional view shown in FIG. 2B, the touch display panel 300 includes an array substrate 310, a touch panel 200, and a liquid crystal layer 320. The liquid crystal layer 320 is sandwiched between the array substrate 310 and the touch panel 200. The array substrate 310 can be an active device array substrate. Besides, the array substrate 310 includes a first substrate 312 and an active layer 314. The first substrate 312 can be a glass substrate, a plastic substrate, or any other appropriate substrate.

The touch panel 200 in the touch display panel 300 of the present embodiment is inverted, and a schematic cross-sectional view of the inverted touch panel 200 is depicted in FIG. 2C for the purpose of elaboration. Referring to FIGS. 2B and 2C together, the touch panel 200 can be a color filter substrate having a touch function. Besides, the touch panel 200 includes a second substrate 210, a touch layer 220, and a color filter layer 230. In the present embodiment, the touch panel 200 can further include a planarization layer 240 and an electrode film 250.

The second substrate 210 can be a glass substrate, a plastic substrate, or any other appropriate substrate. Besides, the second substrate 210 includes a touch area 212 and a non-touch area 214. In the present embodiment, the touch area 212 is disposed in a display area 302 of the touch display panel 300. That is to say, the display area 302 is where the touch screen is positioned. Specifically, not only frames or images can be displayed on the display area 302, but also words or letters can be displayed on the display area 302 and directly chosen from or inputted to the display area 302 by a user.

The touch layer 220 includes a shielding layer 222, touch electrodes 224a, 224b, and signal lines 226a and 226b connected to the touch electrodes 224a and 224b respectively. The signal lines 226a and 226b are illustrated in FIG. 2A. In the present embodiment, the touch layer 220 further includes insulating layers 227 and 228.

According to the present embodiment, the shielding layer 222 is disposed on a surface of the second substrate 210 and has a primary shielding area 222a, a plurality of secondary shielding areas 222b usually smaller than the primary shielding area 222a, and a plurality of transparent areas 222c between primary shielding area 222a and adjacent secondary shielding area 222b or between the adjacent secondary shielding areas 222b, so as to form a lattice-like structure. The shielding layer 222 can be made of a conductive material (e.g. metal) or a non-conductive material (e.g. black resin). The transparent areas 222c can be openings penetrating the shielding layer 222, and the openings are filled with the insulating layer 227 which is mostly on the shielding layer 222.

On the other hand, the touch electrodes 224a, 224b are disposed above the shielding layer 222. A primary gap G1 exists between two adjacent touch electrodes 224a, 224b and corresponds to the primary shielding area 222a. The touch electrodes 224a, 224b can be made of a transparent conductive material, such as indium tin oxide (ITO), cadmium tin oxide (CTO), aluminum zinc oxide (AZO), indium zinc oxide (IZO), zinc oxide (ZnO), tin oxide (SnO), or a combination thereof.

The color filter layer 230 is disposed on the touch layer 220 and includes a plurality of color filter patterns 232. The color filter patterns 232 can be red filter patterns, blue filter patterns, or green filter patterns. Besides, the color filter patterns 232 are disposed corresponding to the transparent areas 222c, and a secondary gap G2 exists between every two of the color filter patterns 232 and is usually smaller than the primary gap G1, which should not be construed as a limitation to the present invention. In another embodiment, the shielding layer 222 and the color filter layer 230 can be in the same layer, and the secondary gaps G2 are filled with the secondary shielding areas 222b of the shielding layer 222.

On the other hand, an insulating layer 227 is disposed between the shielding layer 222 and the touch electrodes 224a, 224b, and an insulating layer 228 is disposed between the color filter layer 230 and the touch electrodes 224a, 224b. The insulating layers 227 and 228 can be made of silicon oxide, silicon nitride, or other dielectric materials.

Moreover, the planarization layer 240 covers the color filter patterns 232, such that the color filter layer 230 can have relatively high planarity. Additionally, the planarization layer 240 can be made of an organic insulating material or an inorganic insulating material. The electrode film 250 is located on the planarization layer 240 for driving the liquid crystal layer 320. Besides, the electrode film 250 can be made of a transparent conductive material, such as ITO, CTO, AZO, IZO, ZnO, SnO, or a combination thereof.

Optical films including polarizers and brightness enhanced films can be further disposed on the touch display panel 300. In the above embodiment, the touch LCD panel 300 is taken as an example, while the present invention should not be construed as limited to the touch LCD panel 300. According to other embodiments, the touch panel 200 can also be assembled to other types of display panels.

The touch electrodes, the signal lines, and the filter patterns are integrated to form the touch panel according to the present embodiment, such that the touch panel is equipped with both the touch function and the color filtering function. Therefore, the touch display panel can be formed by merely assembling the touch panel and the array substrate and filling the liquid crystal layer between the assembled touch panel and array substrate. Namely, the touch display panel 300 is a display panel with built-in touch electrodes and built-in signal lines. Hence, in comparison with the conventional added-type touch display panel of which the touch panel is adhered to the outside of the display panel, the touch display panel 300 of the present invention has a reduced thickness.

Further, in comparison with the conventional integrated-type touch display panel, the touch display panel 300 of the present invention can be formed by performing a rather simplified manufacturing process, and yield of the touch display panel 300 can also be improved. Additionally, in the touch display panel 300, each of the signal lines is merely connected to only one of the touch electrodes. For instance, each of the signal lines 226a is electrically connected only to the corresponding touch electrode 224a but not to other touch electrodes. Note that the signal lines 226a are still connected to external signal receivers or other external devices, so as to transmit signals thereto. Each of the signal lines 226b is electrically connected only to the corresponding touch electrode 224b but not to other touch electrodes. Note that the signal lines 226b are still connected to external signal receivers or other external devices, so as to transmit signals thereto. Therefore, since each of the signal lines is merely connected to only single one touch electrode, the number of the touch electrodes in the panel can be reduced. As such, the unfavorable sensitivity of the touch display panel 300 resulting from the excessive parasitic capacitance which is generated by the excessive touch electrodes can be prevented.

According to the embodiment depicted in FIGS. 2A to 2C, the touch electrodes are disposed in the display area. However, the disposition of the touch electrodes is not limited to the above according to the present invention. The touch electrodes can also be disposed in other areas according to another embodiment of the present invention as described hereinafter.

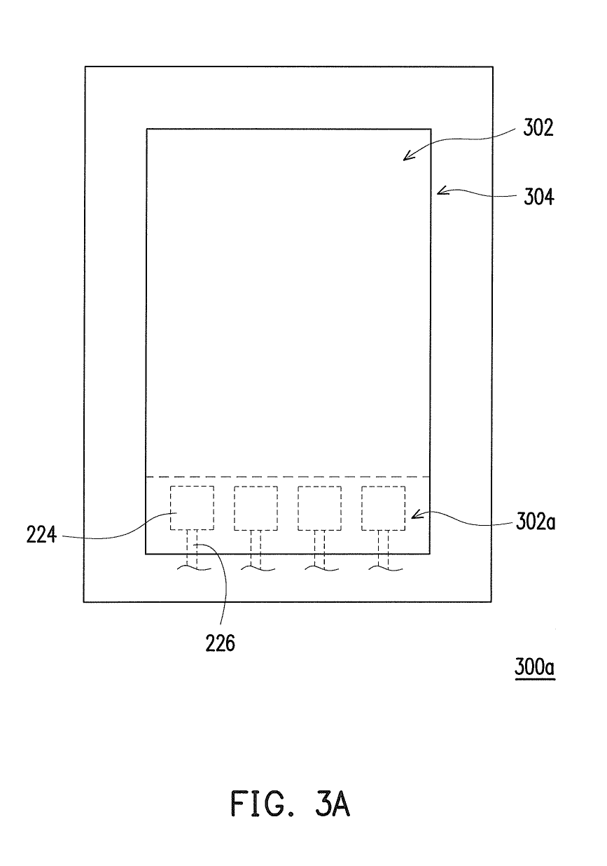

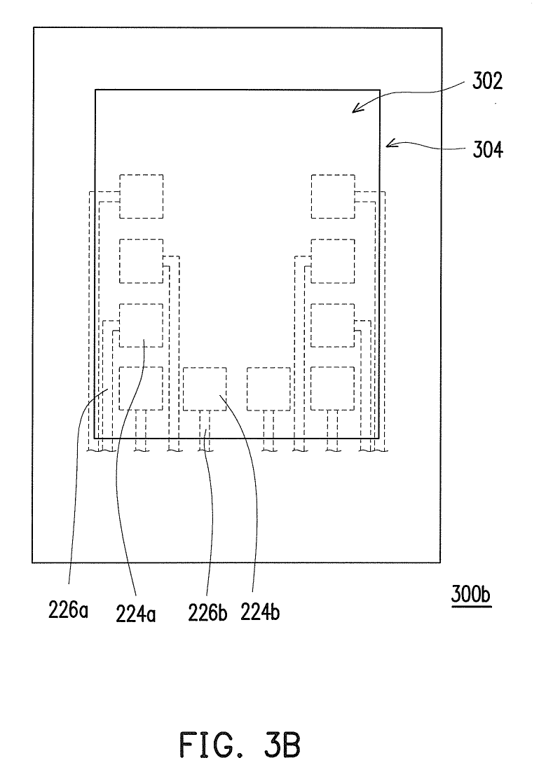

In general, the display panel formed by assembling the array substrate and the color filter substrate is frequently equipped with an embellished housing. The housing often covers a portion of the display area, and the image display area is an area exposed by the housing. In the embodiment depicted in FIG. 3A, the touch electrodes 224 are disposed in a non-image area 302a of the display area 320. Namely, the non-image area 302a is part of the display area 302 but does not serve to display frames or images. As such, the touch electrodes 224 do not pose an impact on actual image display, and consumers' preferences for large-sized display frame can be satisfied.

In addition, the signal lines 226a and 226b of the present embodiment depicted in FIGS. 2A to 2C have different extending directions. However, the different extending directions of the signal lines 226a and 226b should not be construed as a limitation to the present invention. In another embodiment of the present invention as illustrated in FIG. 3B, the signal lines 226a and 226b in a display panel 300b have the same extending direction (e.g. vertical direction).

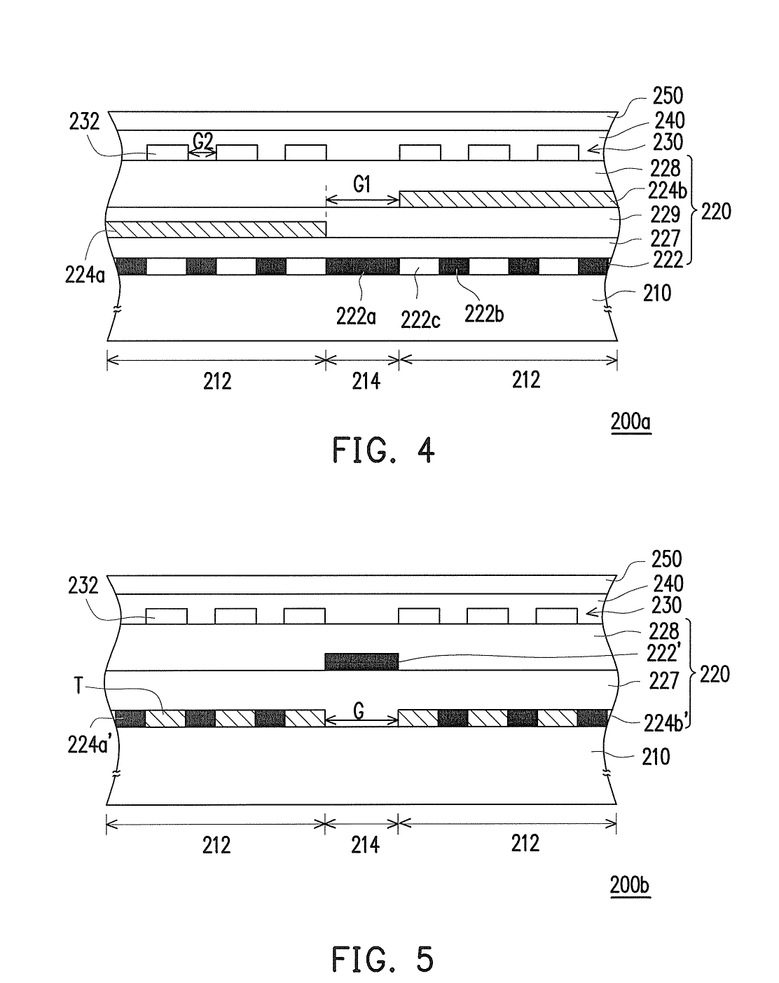

Moreover, in the above embodiment, the structure of the touch panel 200 in the touch display panel 300 is exemplified in FIG. 2C, which should not be construed as limited to the present invention. The structure of the touch panel proposed in the present invention can also be referred to the structures depicted in FIGS. 4-8 and described hereinafter.

### Touch Panel

Referring to FIG. 4, components of a touch panel 200a are similar to those of the touch panel 200 illustrated in FIG. 2B, and therefore the same components are labeled by the same reference numbers. Touch electrodes 224a and 224b in the touch panel 200a are disposed in different film layers. Therefore, an insulating layer 229 insulating the touch electrode 224a from the touch electrode 224b is disposed between the touch electrodes 224a and 224b.

In other words, according to the present embodiment, the touch panel 200a includes a shielding layer 222, an insulating layer 227, the touch electrode 224a, the insulating layer 229, the touch electrode 224b, an insulating layer 228, a color filter layer 230, a planarization layer 240, and an electrode film 250 that are sequentially stacked on a second substrate 210. Here, alternatively, the shielding layer 222 and the color filter layer 230 can be positioned in the same layer, which should not be construed as a limitation to the present invention.

In another embodiment of the present invention as shown in FIG. 5, components of a touch panel 200b are similar to those of the touch panel 200 illustrated in FIG. 2A, and therefore the same components are labeled by the same reference numbers. Touch electrodes 224a′ and 224b′ in the touch panel 200b are disposed on the second substrate 210, and a primary gap G exists between every two of the adjacent touch electrodes 224a′ and 224b′. Besides, each touch electrode 224a′ and each touch electrode 224b′ have a plurality of transparent areas T and a plurality of non-transparent areas, so as to form a lattice-like structure. A material of the touch electrodes 224a′ and 224b′ can be a non-transparent conductive material, such as tantalum, chromium, molybdenum, titanium, aluminum, and so on. The transparent areas T can be openings penetrating the touch electrodes 224a′ and 224b′, and the openings can be filled with a transparent conductive material, such as ITO, CTO, AZO, IZO, ZnO, SnO, or a combination thereof.

A primary shielding area 222′ of the shielding layer 222 is correspondingly disposed above the primary gap G between the touch electrodes 224a′ and 224b. The color filter patterns 232 are located above the primary shielding area 222′ and the touch electrodes 224a′ and 224b′. Besides, the color filter patterns 232 are arranged corresponding to the transparent areas T of the touch electrodes 224a′ and 224b′. Here, alternatively, the shielding layer 222 can be in the same layer together with the touch electrode 224a′, the touch electrode 224b′, or the color filter layer 230, which should not be construed as a limitation to the present invention.

In other words, according to the present embodiment, the touch panel 200b includes the touch electrodes 224a′ and 224b′, an insulating layer 227, the primary shielding area 222′, an insulating layer 228, the color filter layer 230, a planarization layer 240, and an electrode film 250 that are sequentially stacked on a second substrate 210.

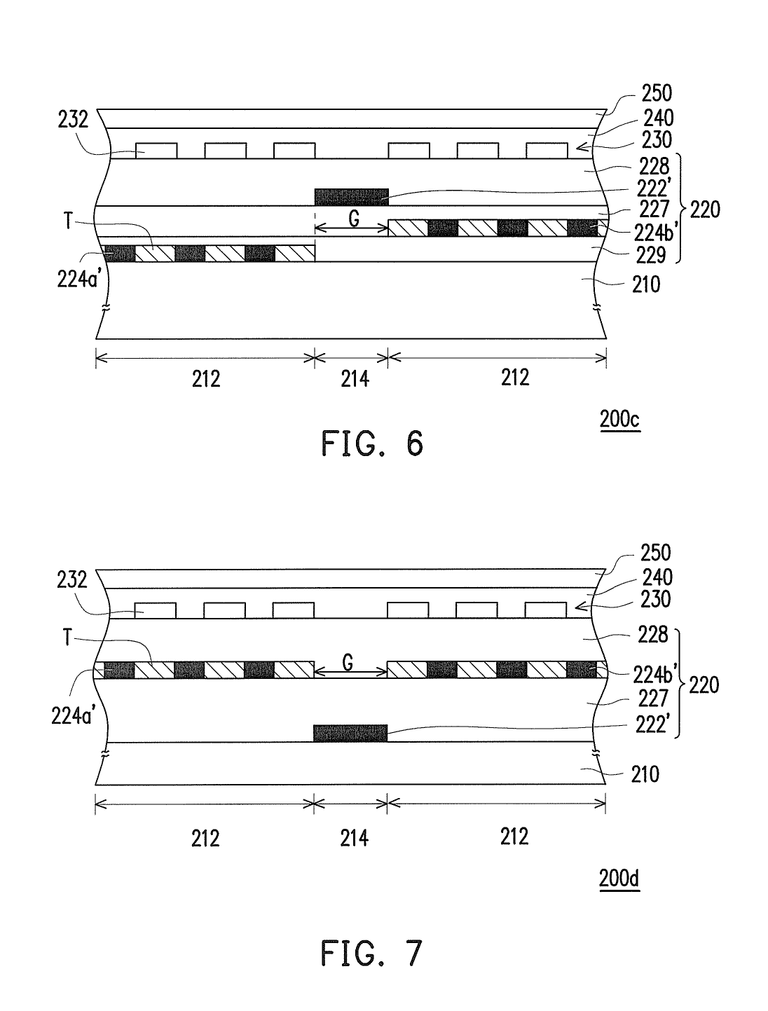

FIG. 6 is a schematic partial cross-sectional view of a touch panel according to a fourth embodiment of the present invention. Components of the touch panel 200c in FIG. 6 are similar to those of the touch panel 200b illustrated in FIG. 5, and therefore the same components are labeled by the same reference numbers. Touch electrodes 224a′ and 224b′ in the touch panel 220c are formed by different film layers. Therefore, an insulating layer 229 insulating the touch electrode 224a′ from the touch electrode 224b′ is disposed between the touch electrodes 224a′ and 224b′.

That is to say, according to the present embodiment, the touch panel 200c includes the touch electrode 224a′, the insulating layer 229, the touch electrode 224b′, an insulating layer 227, a primary shielding area 222′, an insulating layer 228, a color filter layer 230, a planarization layer 240, and an electrode film 250 that are sequentially stacked on a second substrate 210. Here, alternatively, the primary shielding area 222′ can be in the same layer together with the touch electrode 224a′, the touch electrode 224b′, or the color filter layer 230, which should not be construed as a limitation to the present invention.

In another embodiment of the present invention as shown in FIG. 7, components of a touch panel 200d are similar to those of the touch panel 200b illustrated in FIG. 5, and therefore the same components are labeled by the same reference numbers. Touch electrodes 224a′ and 224b′ in the touch panel 200d are located between a primary shielding area 222′ and a color filter layer 230.

Namely, according to the present embodiment, the touch panel 200d includes the primary shielding area 222′, an insulating layer 227, the touch electrodes 224a′ and 224b′, an insulating layer 228, the color filter layer 230, a planarization layer 240, and an electrode film 250 that are sequentially stacked on a second substrate 210. Here, alternatively, the primary shielding area 222′ can be in the same layer together with the touch electrode 224a′, the touch electrode 224b′, or the color filter layer 230, which should not be construed as a limitation to the present invention.

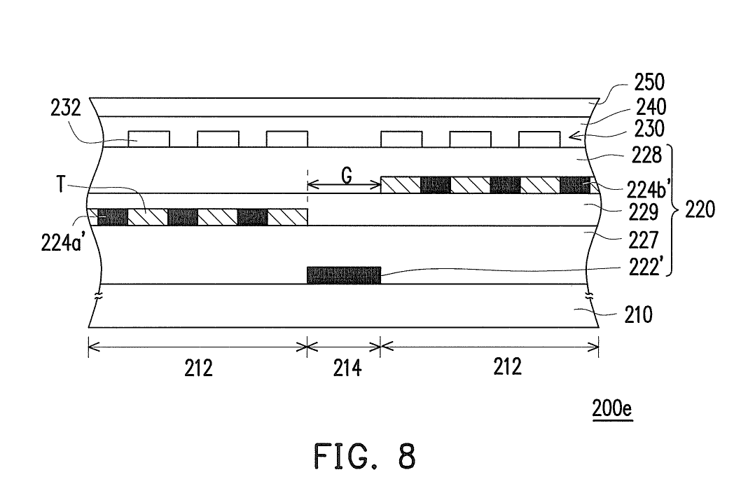

In another embodiment of the present invention as shown in FIG. 8, components of a touch panel 200e are similar to those of the touch panel 200d illustrated in FIG. 7, and therefore the same components are labeled by the same reference numbers. Touch electrodes 224a′ and 224b′ in the touch panel 220e are formed by different film layers. Therefore, an insulating layer 229 insulating the touch electrode 224a′ from the touch electrode 224b′ is disposed between the touch electrodes 224a′ and 224b′.

Namely, according to the present embodiment, the touch panel 200e includes a primary shielding area 222′, an insulating layer 227, the touch electrode 224a′, the insulating layer 229, the touch electrode 224b′, an insulating layer 228, a color filter layer 230, a planarization layer 240, and an electrode film 250 that are sequentially stacked on a second substrate 210. Here, alternatively, the primary shielding area 222′ can be in the same layer together with the touch electrode 224a′, the touch electrode 224b′, or the color filter layer 230, which should not be construed as a limitation to the present invention.

The touch panel respectively illustrated in FIGS. 4 to 8 can be assembled to the array substrate 310 depicted in FIG. 2, and the touch LCD panel can be formed after the liquid crystal layer 320 is filled between the assembled touch panel and array substrate 310.

In light of the foregoing, the touch display panel of the present invention is a display panel with built-in touch electrodes and built-in signal lines. Therefore, in comparison with the conventional touch display panel formed by adhering the touch panel to the display panel, the touch display panel of the present invention has a reduced thickness and can be formed by performing a simplified manufacturing process, so as to comply with current market demands on miniature electronic products and to increase yield of the touch display panel.

Moreover, in the touch display panel of the present invention, each of the signal lines is connected only to only one of the touch electrodes, such that the number of the touch electrodes in the panel is decreased. As such, the unfavorable sensitivity of the touch display panel resulting from the excessive parasitic capacitance which is generated by the excessive touch electrodes can be prevented.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display panel, comprising:
an array substrate;
a color filter substrate disposed opposite to the array substrate and having a touch area and a non-touch area, the color filter substrate comprising:
a shielding layer having a plurality of transparent areas;
a plurality of touch electrodes disposed in the touch area and above the shielding layer;
a plurality of signal lines disposed above the shielding layer, each of the signal lines being connected to only one of the touch electrodes; and
a plurality of color filter patterns disposed above the touch electrodes and corresponding to the transparent areas of the shielding layer; and
a liquid crystal layer sandwiched between the array substrate and the color filter substrate.

2. The touch display panel as claimed in claim 1, wherein
the touch electrodes comprise a plurality of first touch electrodes and a plurality of second touch electrodes; and
the signal lines comprise a plurality of first signal lines and a plurality of second signal lines,
wherein each of the first signal lines is connected to only one of the first touch electrodes and extends along a first direction, and each of the second signal lines is connected to only one of the second touch electrodes and extends along a second direction different from the first direction.

3. A touch display panel, comprising:
an array substrate;
a color filter substrate disposed opposite to the array substrate and having a touch area and a non-touch area, the color filter substrate comprising:
a plurality of touch electrodes disposed in the touch area, each of the touch electrodes having a plurality of transparent areas;
a plurality of signal lines, each of the signal lines being connected to only one of the touch electrodes;
a shielding layer disposed corresponding to a gap between the every two adjacent touch electrodes; and
a plurality of color filter patterns disposed above the touch electrodes and the shielding layer, the color filter patterns corresponding to the transparent areas of the touch electrodes; and
a liquid crystal layer sandwiched between the array substrate and the color filter substrate.

4. The touch display panel as claimed in claim 3, wherein
the touch electrodes comprise a plurality of first touch electrodes and a plurality of second touch electrodes; and
the signal lines comprise a plurality of first signal lines and a plurality of second signal lines,
wherein each of the first signal lines is connected to only one of the first touch electrodes and extends along a first direction, and each of the second signal lines is connected to only one of the second touch electrodes and extends along a second direction different from the first direction.

5. A touch panel, comprising:
a substrate;
a touch layer disposed on the substrate and comprising a first touch electrode, a first signal line, and a shielding layer, the first signal line being electrically connected only to the first touch electrode; and
a color filter layer disposed on the substrate.

6. The touch panel as claimed in claim 5, wherein the first touch electrode has a non-transparent area and a transparent area.

7. The touch panel as claimed in claim 6, wherein the touch layer further comprises a first insulating layer disposed between the first touch electrode and the shielding layer.

8. The touch panel as claimed in claim 6, wherein the touch layer further comprises a first insulating layer disposed between the first touch electrode and the color filter layer.

9. The touch panel as claimed in claim 6, wherein the touch layer further comprises a first insulating layer disposed between the shielding layer and the color filter layer.

10. The touch panel as claimed in claim 5, wherein the touch layer further comprises a second touch electrode and a second signal line, and the second signal line is electrically connected only to the second touch electrode.

11. The touch panel as claimed in claim 10, wherein the second touch electrode has a non-transparent area and a transparent area.

12. The touch panel as claimed in claim 11, wherein the touch layer further comprises a second insulating layer disposed between the second touch electrode and the first touch electrode.

13. The touch panel as claimed in claim 11, wherein the touch layer further comprises a second insulating layer disposed between the second touch electrode and the shielding layer.

14. The touch panel as claimed in claim 11, wherein the touch layer further comprises a second insulating layer disposed between the second touch electrode and the color filter layer.

15. The touch panel as claimed in claim 10, wherein the first signal line is parallel to the second signal line.

16. The touch panel as claimed in claim 10, wherein a primary gap exists between the first touch electrode and the second touch electrode.

17. The touch panel as claimed in claim 16, wherein the shielding layer comprises a primary shielding area corresponding to the primary gap.

18. The touch panel as claimed in claim 17, wherein the color filter layer comprises a plurality of color filter patterns, and a secondary gap exists between every two of the color filter patterns.

19. The touch panel as claimed in claim 18, wherein the shielding layer further comprises a secondary shielding area corresponding to the secondary gap.

20. The touch panel as claimed in claim 5, the shielding layer can be in the same layer together with the first touch electrode.

21. The touch panel as claimed in claim 10, the shielding layer can be in the same layer together with the second touch electrode.

22. A touch display panel, comprising:
an array substrate;
a touch panel as claimed in claim 5 disposed opposite to the array substrate; and
a liquid crystal layer, sandwiched between the array substrate and the touch panel.
